(19) United States
(12) Patent Application Publication
(10) Pub. No.: US 2025/0280414 A1
(43) Pub. Date: Sep. 4, 2025

(54) TRANSMISSION OF SRS OR CSI BASED REPORTS IN SKIPPED CONFIGURED GRANT OCCASIONS

(71) Applicant: QUALCOMM Incorporated, San Diego, CA (US)

(72) Inventors: Zhichao ZHOU, Beijing (CN); Ahmed ELSHAFIE, San Diego, CA (US); Huilin XU, Temecula, CA (US); Diana MAAMARI, San Diego, CA (US)

(21) Appl. No.: 18/857,806

(22) PCT Filed: Jun. 30, 2022
(86) PCT No.: PCT/CN2022/102757

§ 371 Date: Oct. 17, 2024

(51) Int. Cl. H04W 72/21; H04L 5/00; H04W 24/10; H04W 72/12

(52) U.S. Cl. CPC H04W 72/21; H04L 5/0048; H04L 5/0055; H04W 24/10; H04W 72/12

(57) ABSTRACT

A UE receives a configured grant for physical uplink shared channel (PUSCH) transmissions. The UE skips a PUSCH transmission in at least a portion of a configured grant occasion and transmits one or more of a sounding reference signal (SRS) or a channel state information (CSI) based report in the configured grant occasion. A network node outputs for transmission a configured grant for a UE to transmit PUSCH transmissions. The network node receives one or more of a SRS or a CSI based report in a portion of a configured grant occasion.

### TECHNICAL FIELD

The present disclosure relates generally to communication systems, and more particularly, to wireless communication including a configured grant.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives a configured grant for physical uplink shared channel (PUSCH) transmissions. The apparatus skips a PUSCH transmission in at least a portion of a configured grant occasion and transmits one or more of a sounding reference signal (SRS) or a channel state information (CSI) based report in the configured grant occasion.

In an aspect of the disclosure, a method, a computer-readable medium, and an apparatus are provided for wireless communication at a network node. The apparatus outputs for transmission a configured grant for a UE to transmit PUSCH transmissions; and receives one or more of a SRS or a CSI based report in a portion of a configured grant occasion.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4A and FIG. 4B illustrate examples aspects of uplink resource allocation and PUSCH transmission, in accordance with various aspects of the present disclosure.

FIG. 5 illustrates example aspects of SRS transmission and measurement and report of CSI-RS and SSB, in accordance with various aspects of the present disclosure.

FIG. 6A, FIG. 6B, and FIG. 6C illustrate various aspects in connection with PUSCH transmission and skipped occasions for a configured grant, in accordance with various aspects of the present disclosure.

FIG. 7 is a communication including the transmission of SRS/CSI reports in a configured grant occasion, in accordance with various aspects of the present disclosure.

FIG. 8 is a communication including the transmission of SRS/CSI reports in a configured grant occasion, in accordance with various aspects of the present disclosure.

FIG. 9 is a communication including the transmission of SRS/CSI reports in a configured grant occasion, in accordance with various aspects of the present disclosure.

FIG. 10 is a communication including the transmission of SRS/CSI reports in a configured grant occasion, in accordance with various aspects of the present disclosure.

FIG. 11 is a communication including the transmission of SRS/CSI reports in a configured grant occasion, in accordance with various aspects of the present disclosure.

FIG. 12A and FIG. 12B are flowcharts of methods of wireless communication, in accordance with various aspects of the present disclosure.

FIG. 13 is a diagram illustrating an example of a hardware implementation for an example apparatus and/or UE, in accordance with various aspects of the present disclosure.

FIG. 14A and FIG. 14B are flowcharts of methods of wireless communication, in accordance with various aspects of the present disclosure.

FIG. 15 is a diagram illustrating an example of a hardware implementation for an example network entity, in accordance with various aspects of the present disclosure.

### DETAILED DESCRIPTION

A UE may receive a configured grant that provides semi-static or periodic uplink resources that the UE may use to transmit PUSCH transmissions. At one or more configured grant occasion, the UE may not have data to transmit and may skip PUSCH transmission in the configured grant occasion. A configured grant occasion in which the UE does not transmit a PUSCH transmission may be referred to herein as a “skipped configured grant occasion,” a “skipped CG occasion,” or a “skipped occasion.”

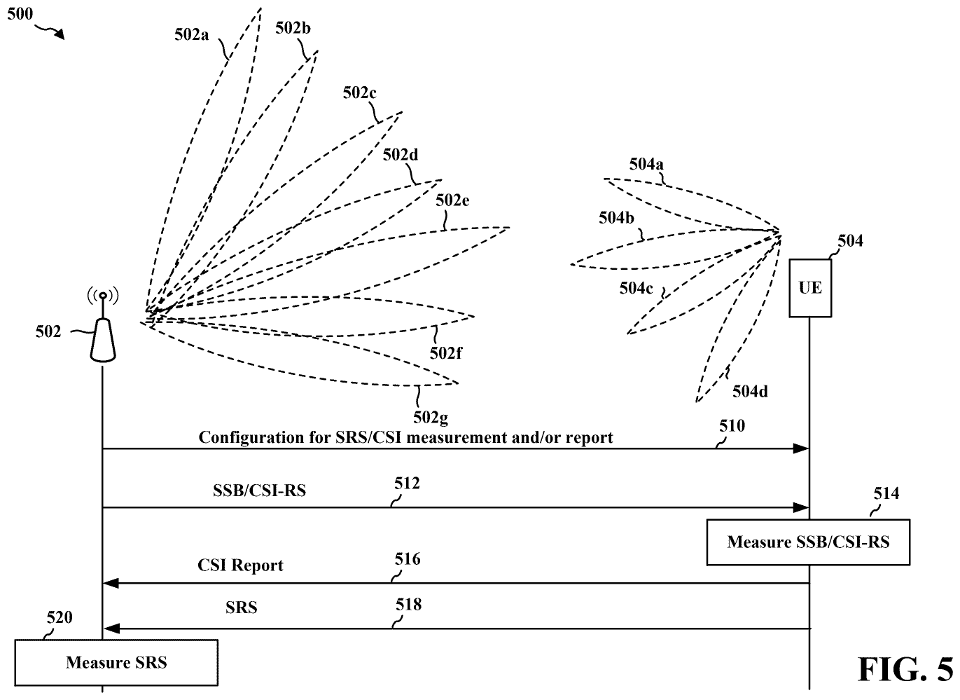

As presented herein, in order to improve the efficient use of wireless resources and to avoid or reduce waste associated with skipped configured grant occasions, the UE may transmit SRS and/or CSI based reports in a configured grant occasion for which the UE does not have uplink data for a PUSCH transmission or has uplink data that is less than the resources of the configured grant occasion. The use of the skipped configured grant occasion to transmit SRS and/or CSI based reports provides greater flexibility than the scheduled SRS/CSI reporting described in connection with FIG. 5. The added flexibility in the SRS transmission and/or the CSI related measurement reports may improve beam selection and/or beam recovery, and may enable a modulation and coding scheme (MCS) for communication between the base station and the UE to be selected based on a more accurate channel state between the UE and the base station.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

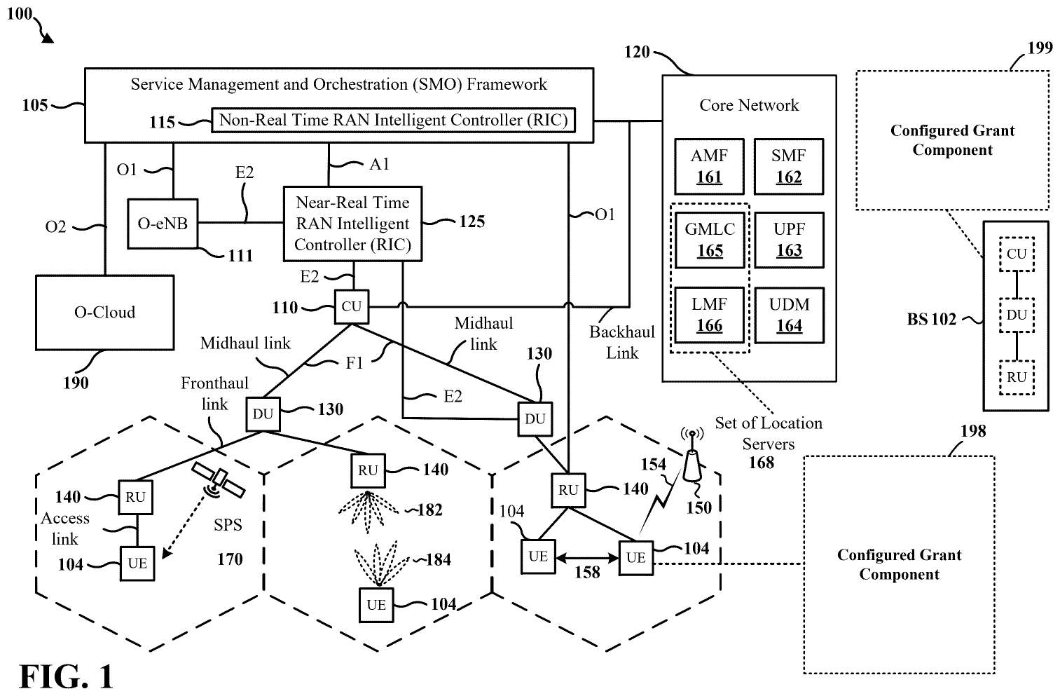

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a configured grant component 198 that is configured to receive a configured grant for PUSCH transmissions, skip a PUSCH transmission in at least a portion of a configured grant occasion and transmits one or more of a SRS or a CSI based report in the configured grant occasion. In certain aspects, the base station 102, or a component of the base station such as a CU, DU and/or RU, may include a configured grant component 199 that is configured to output for transmission a configured grant for a UE to transmit PUSCH transmissions and receive one or more of a SRS or a CSI based report in a portion of a configured grant occasion. Although the following description may be focused on 5G NR, the concepts described herein may be applicable to other similar areas, such as LTE, LTE-A, CDMA, GSM, and other wireless technologies.

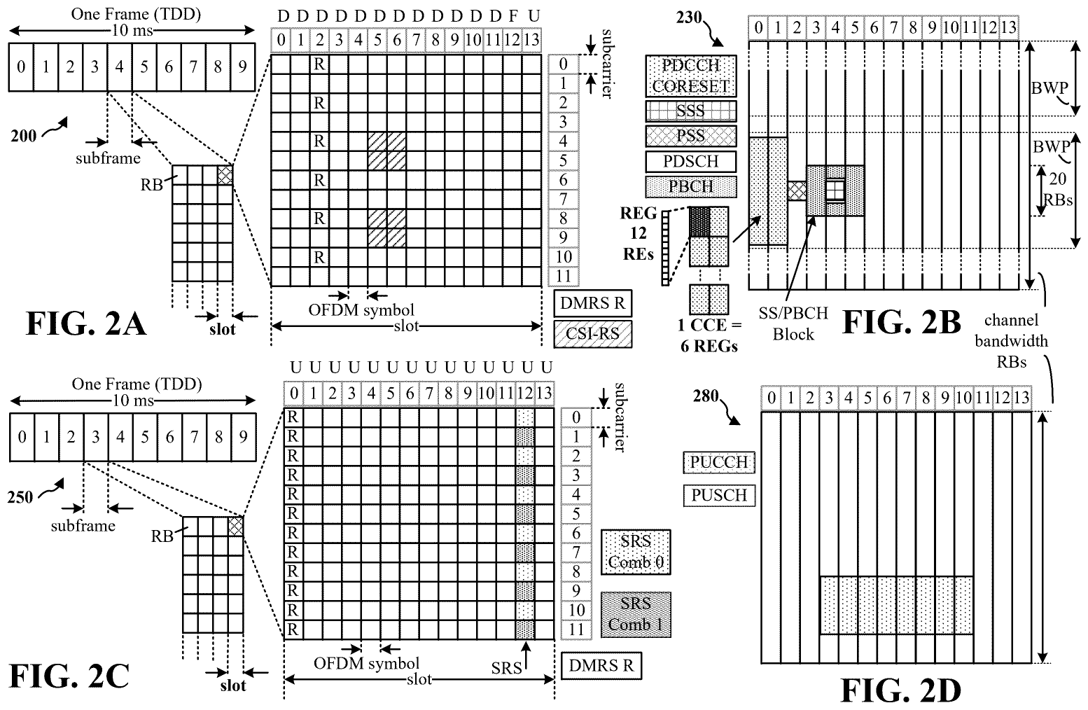

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

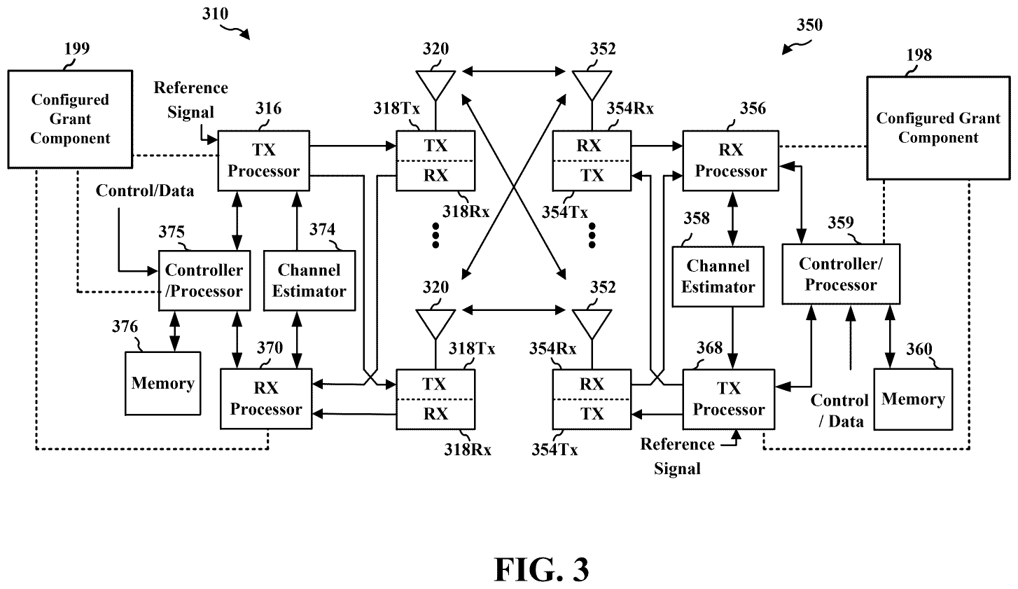

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the configured grant component 198 of FIG. 1.

At least one of the TX processor 316, the RX processor 370, and the controller/processor 375 may be configured to perform aspects in connection with the configured grant component 199 of FIG. 1.

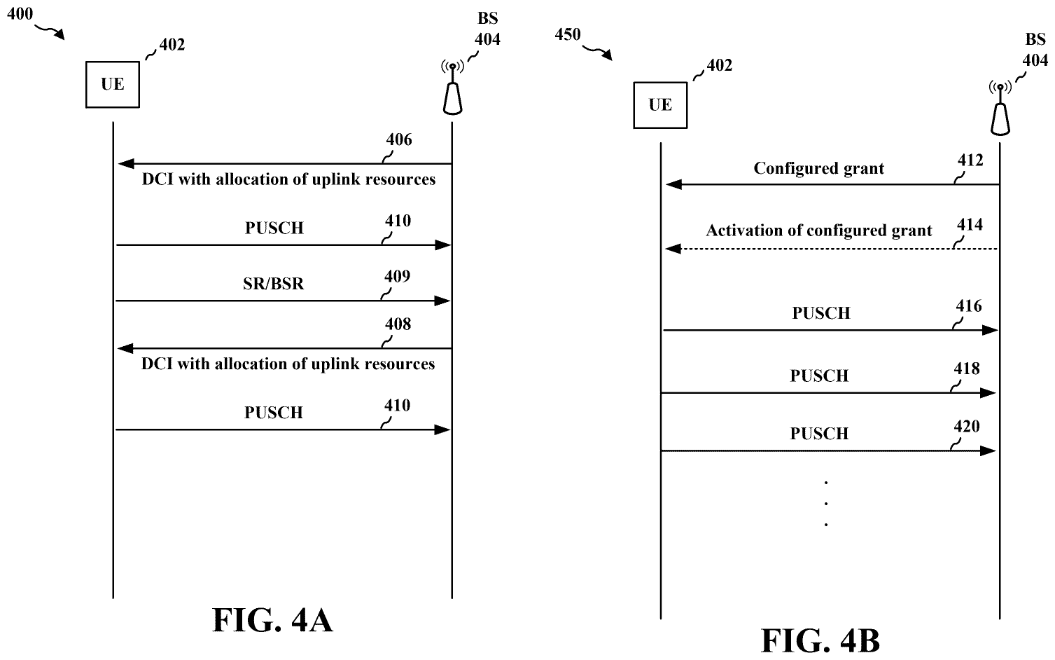

FIG. 4A illustrates a communication flow 400 between a UE 402 and a base station 404, where the UE receives a DCI 406 that provides the UE with an allocation of uplink resources for a PUSCH transmission. The allocation of uplink resources may be referred to as an uplink grant. The UE 402 then transmits the PUSCH transmission 410 using the allocated uplink resources indicated in the DCI. The UE may later receive another DCI 408 with an additional allocation of uplink resources for a PUSCH transmission. The UE 402 transmits the PUSCH transmission 410 using the resources allocated in the DCI 408. The allocation of uplink resources through an uplink grant in DCI may be referred to as a dynamic grant of uplink resources. In order to transmit the PUSCH, the UE may wait for the DCI providing the uplink grant. In some aspects, the UE 402 may transmit a scheduling request (SR) and/or a buffer status report (BSR), such as shown at 409, to trigger the DCI providing the uplink grant for the PUSCH.

FIG. 4B illustrates an example communication flow 450 between the UE 402 and the base station 404 in which the base station 404 provides the UE 402 with a configured grant 412 that indicates periodic or semi-static resources that are granted to the UE 402 for uplink transmission, e.g., for PUSCH. The configured grant may include parameters indicating time and frequency resources, periodicity, repetition, or other configurations. The configured grant may be provided to the UE, for example, in radio resource control (RRC) signaling. In some aspects, the UE 402 may receive an activation, at 414, of the configured grant. The UE 402 may use the resources indicated in the configured grant to transmit PUSCH transmissions, e.g., 416, 418, and 420, based on the activation of the configured grant. In some aspects, the activation may be in a MAC-CE, or other control signaling. The UE may continue to use the periodic/semi-static resources of the configured grant to transmit PUSCH transmissions until the UE receives a deactivation of the configured grant, until a different configured grant is activated, or until another condition occurs that indicates for the UE to stop using the resources of the configured grant. In some aspects, the UE may use the resources of the configured grant based on the configuration, at 412, and without an activation. The UE 402 may continue to use the periodic/semi-static resources of the configured grant to transmit PUSCH transmissions, e.g., 416, 418, and 420, until the UE receives an indication to stop using the configured grant or until another condition occurs that indicates for the UE to stop using the resources of the configured grant.

Configured grant based transmissions may have lower latency, because the UE 402 does not wait for individual DCI with an uplink grant before transmitting a PUSCH transmission, as occurs in FIG. 4A. The configured grant may provide a power savings at the UE 402, because the UE does not transmit a SR or BSR in order to trigger an uplink grant. The configured grant may reduce the overhead for the UE to receive an uplink grant in order to transmit PUSCH transmissions. The configured grant may further save power at the UE, as the UE does not blind decode a PDCCH in order to receive the DCI with an uplink grant before the UE transmits a PUSCH transmission.

FIG. 5 is a diagram 500 illustrating that the base station 502 and UE 504 may communicate over active data/control beams both for DL communication and UL communication. The base station and/or UE may switch to a new beam direction using beam failure recovery procedures. The base station 502 may transmit a beamformed signal to the UE 504 in one or more of the directions 502a, 502b, 502c, 502d, 502c, 502f, or 502g. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training and/or beam management to determine the best receive and transmit directions for each of the base station 502/UE 504. The transmit and receive directions for the base station 502 may or may not be the same. The transmit and receive directions for the UE 504 may or may not be the same.

In response to different conditions, the UE 504 may determine to switch beams, e.g., between beams 502a-502h. The beam at the UE 504 may be used for reception of downlink communication and/or transmission of uplink communication. In some examples, the base station 502 may send a transmission that triggers a beam switch by the UE 504. For example, the base station 502 may indicate a transmission configuration indication (TCI) state change, and in response, the UE 504 may switch to a new beam for the new TCI state of the base station 502. In some instances, a UE may receive a signal, from a base station, configured to trigger a transmission configuration indication (TCI) state change via, for example, a MAC control element (CE) command. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication.

For monitoring active link performances, a UE may perform measurements of at least one signal, e.g., reference signals (RS). The measurements may include deriving a metric similar to a signal to noise and interference ratio (SINR) for the signal, or RSRP strength or block error rate (BLER) of a reference control channel chosen by base station and/or implicitly derived by UE based on the existing RRC configuration. The reference signal may include any of CSI-RS, a synchronization signal block (SSB), or other RS for time and/or frequency tracking, or the like. FIG. 5 illustrates that the base station 502 may transmit a configuration 510 to the UE 504 with a configuration for SRS transmission and/or CSI measurement and reporting. In some aspects, the configuration 510 may be provided to the UE 504 in one or more of RRC signaling, a MAC-CE, or DCI. The UE performs measurements and provides reports based on the received configuration. The configuration 510 may indicate to the UE 504 one or more parameters for SRS transmission, such as a periodicity and offset for the SRS, a number of ports for the SRS, frequency-hopping information for the SRS, and/or a comb-type of the SRS. The UE 504 may then transmit the SRS 518 based on the configuration 510. The base station 502 may measure the SRS, at 520, and may use the measurement to determine a communication parameter for the UE, such as a beam for communication with the UE.

The configuration 510 may be for the UE 504 to obtain channel quality information (CQI) and may indicate to the UE the signal to be measured and reported. In some aspects, the configuration may indicate for the UE 504 to measure a CSI-RS and may indicate a frequency band on which the UE 504 is to conduct measurement (for example the configuration may indicate whether the UE 504 is to perform a subband-based measurement or wideband-based measurement), one or more CSI-RS ports for the UE to measure, a slot and offset for the UE 504 to send a CSI based report, a type of CSI report (e.g., a periodic, semi-persistent, or aperiodic report), or a report periodicity. In such examples, the configuration 510 may include a “csi-reportConfig” or other type of configuration. The configuration 510 may indicate to the UE one or more beam related parameters, e.g., CSI-RS resource indicator (CRI) or SSB resource indicator (SSBRI), a layer 1-RSRP (L1-RSRP), a precoding matrix indicator (PMI), a rank indicator (RI) for the UE 504 to report.

The base station 502 may transmit the indicated reference signal 512 on one or more of the beams (e.g., 502a-g) according to the configuration 510 indicated to the UE. The UE 504 measures the reference signal, at 514, according to the configuration 510. The UE 504 transmits a CSI report 516, or a CSI based report, according to the configuration for the report provided at 510.

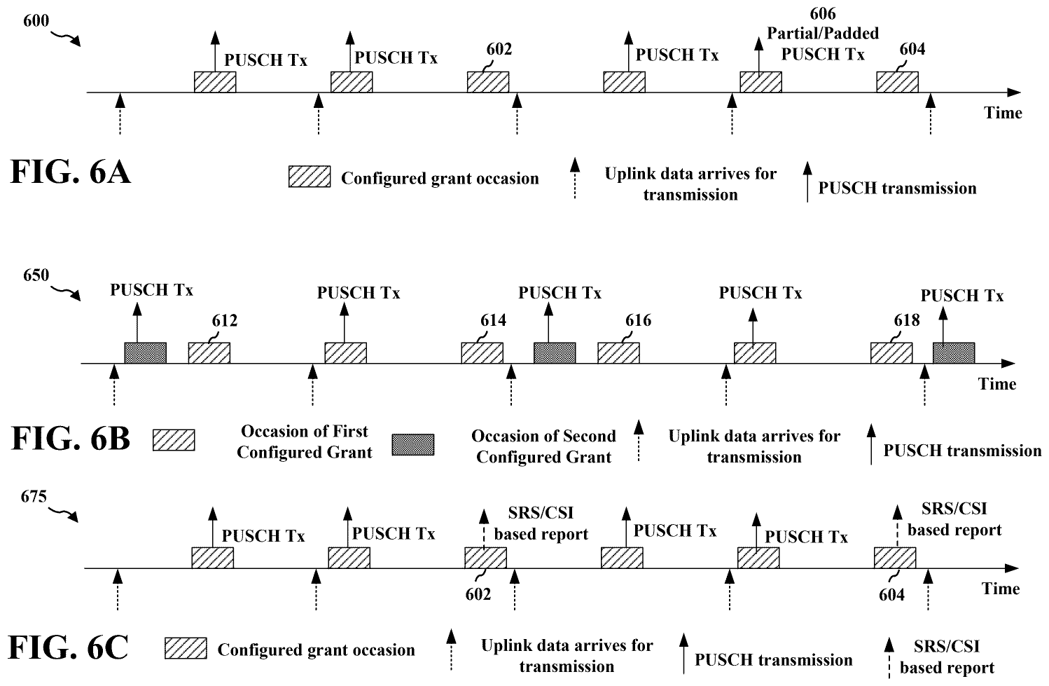

In some aspects, traffic may not arrive for transmission in time for a configured grant occasion. FIG. 6A illustrates an example timeline 600 showing the arrival of uplink traffic for transmission in relation to a set of configured grant occasions. At occasion 602 and 604, uplink traffic has not arrived for transmission, and the UE may skip a PUSCH transmission at the configured grant occasions 602 and 604. Some configured grant occasions may be skipped because of a mismatch between traffic and the configured grant occasions. If no traffic arrives for a particular configured grant occasion, the occasion may be skipped. If traffic size is smaller than the resources allocated for the configured grant, the UE may transmit a PUSCH in part of the configured grant resources, and a portion of the configured grant resources may be skipped or padded for the corresponding configured grant occasion. For example, at 606, the uplink data that has arrived may be smaller than the resources for the configured grant occasion, and the UE may transmit a PUSCH transmission in a portion of the configured grant resources for the occasion or may pad the PUSCH transmission. In some aspects, the UE may receive configurations for multiple types of configured grants in order to cover the potential jitter of uplink traffic arrival. If multiple configured grants are provided for the UE, the UE may use one of the types of configured grants that aligns with the uplink traffic and may skip the configured grant occasions of the other configured grants. For example, FIG. 6B illustrates an example timeline 650 in which the UE may receive a first configured grant and a second configured grant. The different configured grant occasions may enable the UE to transmit uplink traffic with less latency. However, the UE may skip transmission in a larger number of configured grant occasions, e.g., 612, 614, 616, and 618, for example.

In order to improve the efficient use of wireless resources and to avoid or reduce waste associated with skipped configured grant occasions, the UE may transmit SRS and/or CSI based reports in a configured grant occasion for which the UE does not have uplink data for a PUSCH transmission or has uplink data that is less than the resources of the configured grant occasion. The use of the skipped configured grant occasion to transmit SRS and/or CSI based reports provides greater flexibility than the scheduled SRS/CSI reporting described in connection with FIG. 5. The added flexibility in the SRS transmission and/or the CSI related measurement reports may improve beam selection and/or beam recovery, and may enable a modulation and coding scheme (MCS) for communication between the base station and the UE to be selected based on a more accurate channel state between the UE and the base station.

FIG. 6C illustrates an example timeline 675 in which the UE may use the configured grant occasions 602 and 604, for which the UE has not received uplink data traffic for a PUSCH transmission, to transmit SRS and/or a CSI based report. In some aspects, the UE can transmit the SRS and/or report the CSI-based parameters on a skipped configured grant occasion autonomously or according to a configuration from a base station. In some aspects, the UE may determine how to transmit the SRS, what CSI-based parameters to be measured and/or reported on the skipped configured grant occasion, and the UE may inform the base station of the determination, e.g., in a UCI transmission to the base station.

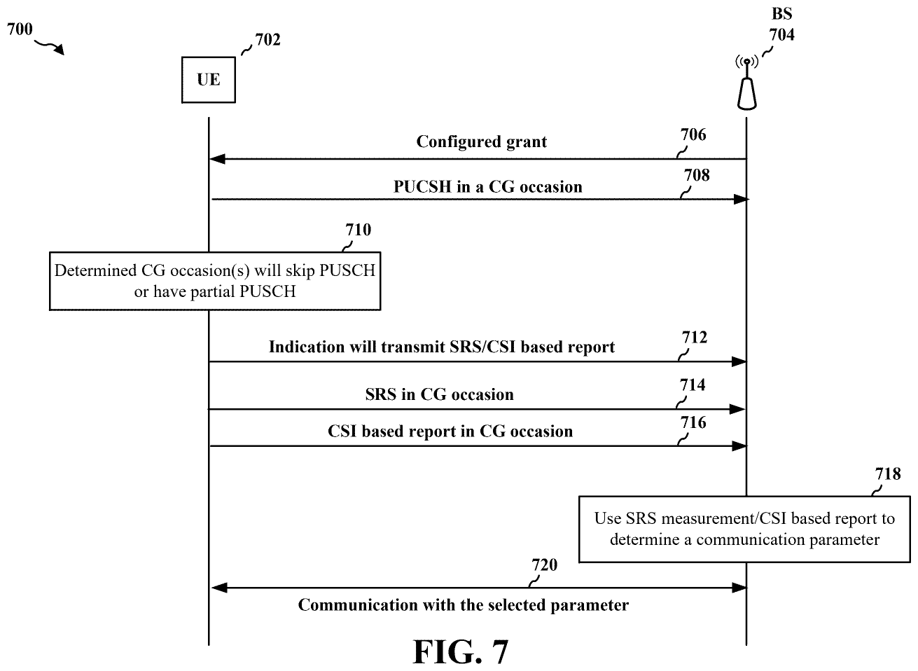

In some aspects, the UE may perform an autonomous transmission of the SRS and/or CSI-based parameters on one or more skipped configured grant occasions. FIG. 7 illustrates an example communication flow 700 between a UE 702 and a base station 704 that includes the transmission of SRS and/or a CSI based report in a skipped configured grant configuration occasion (e.g., a configured grant occasion in which the UE skips the transmission of PUSCH or transmits the PUSCH in only a portion of the occasion's resources). FIG. 7 illustrates that the base station 704 transmits a configured grant 706 to the UE 702 that indicates the parameters of the configured grant, e.g., as described in connection with 412 in FIG. 4B or any of FIGS. 6A-6C. The UE 702 may transmit a PUSCH transmission 708 in one or more of the configured grant occasions, e.g., as described in connection with FIG. 4B or any of FIGS. 6A-6C. In some aspects, the skipped configured grant occasions may be known or identified in advance by the UE. For example, the UE may know the rate of traffic arrival relative to the configured grant occasions and may determine, at 710, one or more configured grant occasions for which the UE will not have data to transmit and/or will have reduced data to transmit. As illustrated at 714, the UE 702 may transmit an SRS in a skipped configured grant occasion (e.g., a configured grant occasion in which the UE does not transmit PUSCH or transmits a PUSCH in a portion of the resources of the configured grant occasion), e.g., as described in connection with FIG. 6C. As illustrated at 716, the UE 702 may transmit a CSI based report (e.g. CSI based measurements) to the base station 704 in the skipped configured grant occasion. The base station 704 may use the SRS measurement and/or the CSI based report to determine a communication parameter for communication with the (e.g., to estimate a downlink or uplink channel, determine a precoding for downlink communication, select a beam, select an MCS, etc.), as shown at 718. Then, the base station 704 may transmit and/or receive communication, at 720, with the UE 702 based on the communication parameter determined at 718.

In some aspects, the UE 702 may transmit the SRS and/or the CSI-based measurements (e.g., a CSI based report), e.g., at 714 and/or 716, based on a self-determination, which may be based on a decoding quality or reception of one or more NACKs from a base station (e.g., such as in an unlicensed spectrum such as NR-U). The transmission of the SRS 714 may assist the base station 704 in estimating the downlink and/or uplink channel and calculating downlink precoding parameters to use with the UE 702. The CSI based measurement reports 716 may help the base station 704 to perform beam selection, beam recovery, beam switching, and/or to select a better MCS index for downlink and/or uplink scheduling of communication with the UE 702.

In some aspects, the UE 702 may indicate to the base station 704, at 712, information about the SRS and CSI-based report that is transmitted on the skipped configured grant occasion(s) with UCI, such as a configured grant UCI (CG-UCI), which may include multiple bits. The information 712, e.g., which may be indicated in the CG-UCI, may include an index of one or more CG occasions that carry SRS and/or a CSI-based report. The information 712 may include a comb-level for the SRS, a comb offset for the SRS, number of ports of SRS, and/or other SRS parameters. The information 712 may include a position of the SRS and CSI-based report in the configured grant occasion, e.g., and may indicate a time domain resource allocation (TDRA) and/or a frequency domain resource allocation (TDRA) that indicates time and/or frequency resources of the SRS/CSI based report. The information may include a CSI based report parameter, such as a CQI, PMI, RI, CRI, etc.

In some aspects, the UE may indicate, at 712, the transmission of the SRS Tx and CSI-based report on skipped configured grant occasions with UCI (such as CG-UCI) and with an indicator in a dedicated indicator area. As an example, at 712, the UE may use one or more bit, e.g., a single bit in some examples, to indicate whether SRS and/or a CSI based report is included in a configured grant occasion. In addition to using the bit to indicate that the SRS/CSI based report is included, the UE may transmit additional information, at 712, about the SRS/CSI based report in resources outside of the UCI that are dedicated for the additional information. As an example, the resources may be PUSCH resources. For example, the UCI may include a “1” to indicate that the configured grant occasion carries the SRS or the CSI based report, or may include a “0” to indicate that no SRS or CSI based report is included in the configured grant occasion. In other examples, a “0” may indicate the presence of the SRS/CSI based report and a “1” may indicate an absence of the SRS/CSI based report. In some aspects, the one or more bits of the UCI may be referred to as a “srs-csi-report” indicator. In some aspects, the inclusion/absence of the SRS and the CSI based report in a configured grant occasion may be indicated separately. If the UCI indicates that the SRS or CSI based report is not included in the configured grant occasion, the base station may skip decoding the resources dedicated for carrying the information about the SRS/CSI based report. As an example, the dedicated resources (e.g., which may be referred to as a dedicated area) may be part of resources for a PUSCH, e.g., PUSCH resources of a configured grant occasion. If the UCI indicates that SRS and/or a CSI based report is included in the configured grant occasion, the base station may proceed to decode the information carried in the dedicated resources/area. The information in the dedicated area may enable the base station to further receive/measure/decode the SRS or CSI based report in the configured grant occasion.

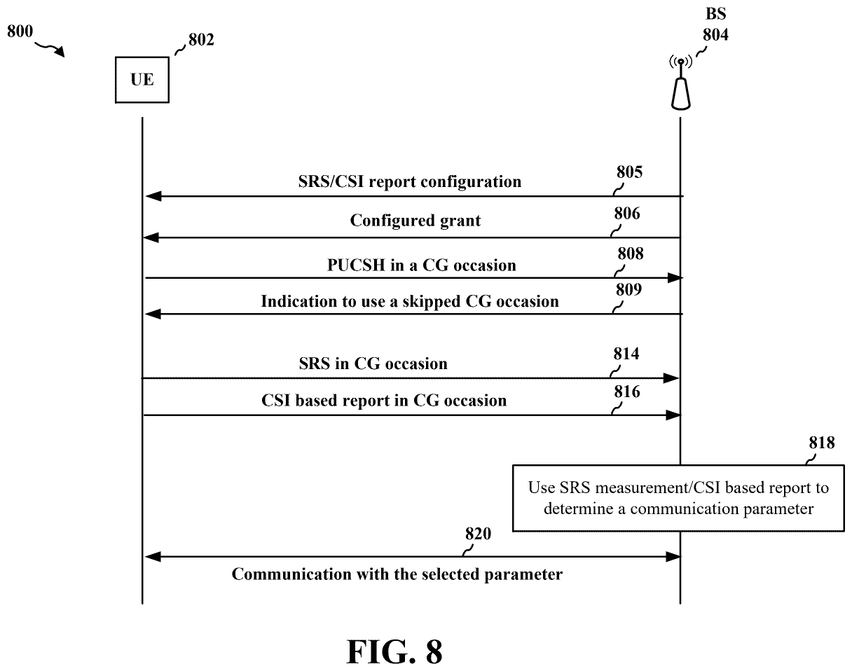

In some aspects, a base station may indicate to the UE to use one or more configured grant occasions for which the UE will skip a PUSCH transmission to transmit. FIG. 8 illustrates an example communication flow 800 between a UE 802 and a base station 804 that includes the transmission of SRS and/or a CSI based report in a skipped configured grant configuration occasion (e.g., a configured grant occasion in which the UE skips the transmission of PUSCH or transmits the PUSCH in only a portion of the occasion's resources), similar to FIG. 7. FIG. 8 illustrates that the base station 804 transmits a configured grant 806 to the UE 802 that indicates the parameters of the configured grant, e.g., as described in connection with 412 in FIG. 4B or any of FIGS. 6A-6C. The UE 802 may transmit a PUSCH transmission 808 in one or more of the configured grant occasions, e.g., as described in connection with FIG. 4B or any of FIGS. 6A-6C. In contrast to FIG. 7, where the UE indicates that the UE will transmit the SRS/CSI based report, in FIG. 8, the base station 804 may transmit an indication to the UE, at 809, to use one or more skipped configured grant occasions (during which the UE will not transmit PUSCH in at least part of the occasion's resources) to transmit the SRS and/or the CSI based report. In some aspects, the indication 809 may be included in DCI to the UE 802. As an example, the indication 809 may be included in DCI carrying ACK/NACK feedback for the PUSCH transmission 808. In some aspects, the indication 809 may indicate for the UE to transmit SRS in a skipped configured grant occasion based on an SRS configuration 805. In some aspects, the indication 809 may indicate for the UE to transmit a CSI report relating to uplink communication in a skipped configured grant occasion based on an CSI report configuration 805. In some aspects, the indication 809 may indicate for the UE to transmit a CSI report relating to downlink communication in a skipped configured grant occasion based on an CSI report configuration 805. The configuration 805 may include any of the aspects described in connection with 510 in FIG. 5.

As illustrated at 814, the UE 802 may transmit an SRS in a skipped configured grant occasion (e.g., a configured grant occasion in which the UE does not transmit PUSCH or transmits a PUSCH in a portion of the resources of the configured grant occasion), e.g., as described in connection with FIG. 6C, and in response to the indication 809. As illustrated at 816, the UE 802 may transmit a CSI based report (e.g. CSI based measurements) to the base station 804 in the skipped configured grant occasion in response to the indication 809. The base station 804 may use the SRS measurement and/or the CSI based report to determine a communication parameter for communication with the (e.g., to estimate a downlink or uplink channel, determine a precoding for downlink communication, select a beam, select an MCS, etc.), as shown at 818. Then, the base station 804 may transmit and/or receive communication, at 820, with the UE 802 based on the communication parameter determined at 818.

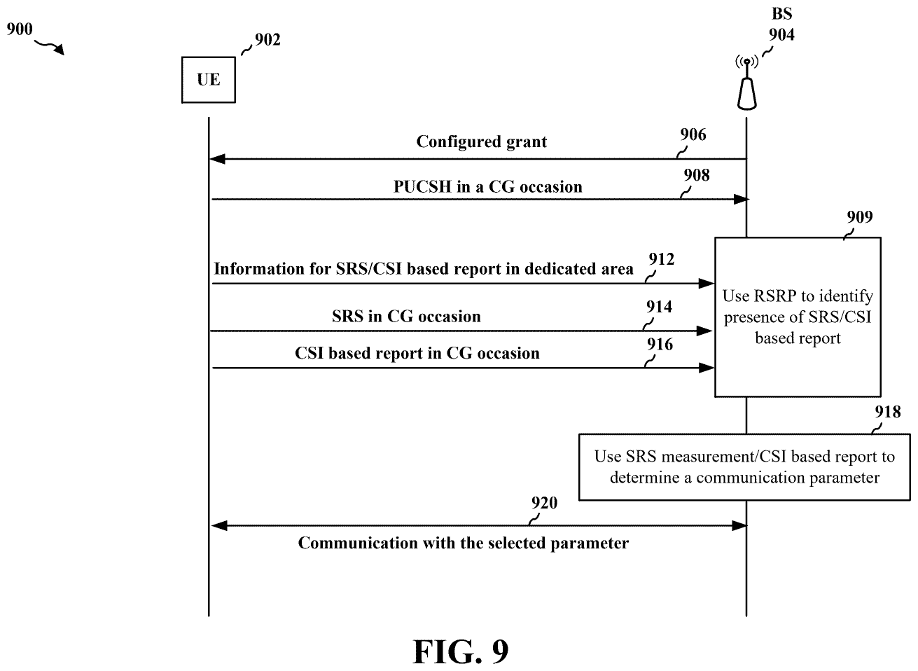

In some aspects, the base station may receive an SRS and/or CSI based report in a configured grant resource based on an RSRP based indicator and information in a dedicated indicator area (e.g., a set of resources dedicated for the reception of information about the SRS or CSI based report). FIG. 9 illustrates an example communication flow 900 between a UE 902 and a base station 904 that includes the transmission of SRS and/or a CSI based report in a skipped configured grant configuration occasion (e.g., a configured grant occasion in which the UE skips the transmission of PUSCH or transmits the PUSCH in only a portion of the occasion's resources). As shown at 906, the base station 904 transmits a configured grant 906 to the UE 902 that indicates the parameters of the configured grant, e.g., as described in connection with 412 in FIG. 4B or any of FIGS. 6A-6C. The UE 902 may transmit a PUSCH transmission 908 in one or more of the configured grant occasions, e.g., as described in connection with FIG. 4B or any of FIGS. 6A-6C.

The UE may determine how to transmit the SRS and/or what parameters to report based on measurement of the CSI-RS, e.g., as described in connection with the example in FIG. 7. In contrast to the example in FIG. 7, in which the UE indicates to the base station that the SRS/CSI based report is transmitted, FIG. 9 illustrates that the base station 904 may determine, at 909, whether an SRS or CSI based report is transmitted in a configured grant occasion based on an RSRP measurement.

In some aspects, the base station 904 may check the specific positions of DMRS of a CSI report, if the RSRP is higher than a threshold, the base station 904 may determine that the CG occasion carries a CSI-based report 916. In response to the determination, the base station may further decode the CSI-based report(s) 916.

In some aspects, the base station 904 may check the RSRP of a signal received in a CG occasion. If the end N OFDMs, N being a positive integer number, have a higher RSRP than the former OFDMs in a prior CG slot, the base station may determine that the CG occasion carries an SRS transmission 914.

In some aspects, if the RSRP measurement indicates that presence of the CSI based report and/or the SRS transmission, the base station 904 may then decode information 912 in a dedicated indicator area (e.g., a dedicated set of resources for the SRS/CSI based report information) to obtain the parameters of the SRS/CSI based report in order to receive/measure the CSI based report or SRS. For example, the information 912 may include similar information to the parameters described in connection with 712. The base station 904 may then receive/decode the SRS/CSI-based report according to the information indicated at 912.

The base station 904 may use the SRS measurement and/or the CSI based report to determine a communication parameter for communication with the (e.g., to estimate a downlink or uplink channel, determine a precoding for downlink communication, select a beam, select an MCS, etc.), as shown at 918. Then, the base station 804 may transmit and/or receive communication, at 920, with the UE 902 based on the communication parameter determined at 918.

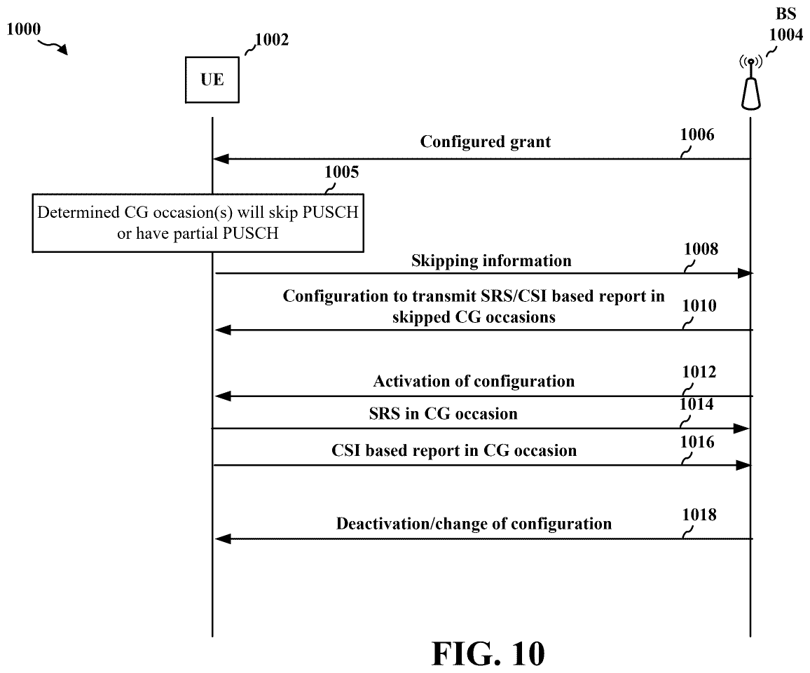

In some aspects, the base station may configure the UE to transmit the SRS/CSI-based report in skipped configured grant occasions based on a configured pattern for a time window. FIG. 10 illustrates an example communication flow 1000 between a UE 1002 and a base station 1004 that includes a configuration to transmit SRS and/or a CSI based report in skipped configured grant configuration occasions. As shown at 1006, the base station 1004 transmits a configured grant 1006 to the UE 1002 that indicates the parameters of the configured grant, e.g., as described in connection with 412 in FIG. 4B or any of FIGS. 6A-6C. The UE 1002 may transmit a PUSCH transmission in one or more of the configured grant occasions, e.g., as described in connection with FIG. 4B or any of FIGS. 6A-6C.

As described in connection with FIG. 7, the UE 1002 may determine, at 1005, one or more configured grant occasions for which the UE will skip PUSCH transmission or have a PUSCH transmission than is smaller than the configured grant occasion resources. The UE 1002 may indicate, at 1008, information to the base station 1004 about the one or more configured grant occasions that the UE will skip. Such information may be referred to as skipping information.

As an example, the UE may provide the base station with the skipping information in UCI over a PUCCH. In some aspects, the UE may use the control signaling to convey the resources that the UE has used, that the UE prefers to use, that the UE will use, that the UE will skip, or that the UE has skipped. The indication in the UCI may allow the UE to flexibly choose time and/or frequency resources for the uplink transmission. The UCI may indicate the skipped resources of the configured grant, e.g., on which a PUSCH transmission is not transmitted. The UCI may indicate the utilized resources of the configured grant, e.g., in which the PUSCH is transmitted. In some aspects, the UCI may indicate the number of RBs of the configured grant that the UE selects for the PUSCH transmission, or an indication of the time frequency resources for the PUSCH transmission. For example, the UCI may indicate information about one or more slots, one or more symbols, one or more RBs, and/or one or more RBGs. The UCI may be transmitted in the same slot as resources for a PUSCH transmission or may be transmitted in a different slot than a PUSCH transmission (and may include a slot indicator to indicate the corresponding slot of the PUSCH). The UE may transmit the UCI dynamically, such as before every PUSCH transmission. The UE may transmit the UCI aperiodically, such as triggered through DCI signaling. The UE may transmit the UCI once or may be transmitted periodically to change a CG-PUSCH allocation. The UE may combine the UCI with other UCI (e.g., ACK/NACK) transmitted on PUSCH. If the UE has data in its buffer but no UCI ACK/NACK, the UE may send this UCI with SI.

In some aspects, the base station may provide multiple uplink grant, e.g., UL-CGs, and the UE may choose one of the multiple UL-CGs to transmit PUSCH. The base station may configure multiple CG-PUSCH overlapping in time, and UE may choose one for the transmission of data. In some aspects, the base station may blindly decode the PUSCH transmission. This example may allow the UE to dynamically choose resources within the chosen configured grant, e.g., via UCI, and the UE may continue to transmit the PUSCH. The UE may indicate to the base station an index for the selected configured grant. This UE may dynamically choose resources in UL without sending UCI with gNB performing blind detection. In some aspects, a base station may allocate multiple dynamic grant PUSCH, and the UE may select one for the transmission of PUSCH.

In some aspects, reserved REs to indicate skipped RBs (e.g., RBs of a configured grant on which the UE does not transmit PUSCH). In some aspects, the UE may provide an indication within each RB to indicate whether RBs/symbols are used by the UE for the uplink transmission. If the UE skipping granularity is at the RB level, the UE may skip RBs (e.g., not transmit PUSCH in the RBs) yet may use each of the granted OFDM symbols (e.g., by transmitting in each of the OFDM symbols).

Within a configured grant, the base station may reserve PUSCH REs for the UE to provide a skipping indication. In some aspects, the reserved REs may be provided in each RB of the configured grant. The UE may provide an indication in the reserved REs, e.g., a specific type of modulation, a zero power, or a particular RS signal that indicates that the UE skips PUSCH transmission in the corresponding RB. Alternatively, the UE may provide an indication in the reserved REs, e.g., a specific type of modulation, a zero power, or a particular RS signal that indicates that the UE will transmit a PUSCH transmission in the corresponding RB. These resources that are reserved for the indication may be configured for the UE in an RRC message. The RRC configuration may include a pattern type, a location of the resource (e.g., a location of the RE), or other configuration information. Although the example is described for reserved RE(s) in an RB, the concept can be applied for other reserved resources. As an example, the resource may be reserved for the UE to indicate whether or not an OFDM symbol of a configured grant is skipped for a PUSCH transmission. As another example, the UE may indicate the skipping information in the frequency domain (e.g., for one or more skipped RBs) and in the time domain (e.g., for one or more skipped symbols). In some aspects, the reserved resource for the indication may be frontloaded, e.g., in order to reduce latency.

In some aspects, the base station may limit the scope of the skipping, which may reduce the blind detection at the base station. While the base station may allow a UE to skip some resources in an uplink transmission, the base station may guide the UE in a skipping mechanism. For example, the base station may configure a starting PRB where the UE it to transmit when implementing flexible uplink skipping. The base station may configure (e.g., in RRC signaling), an RB comb pattern for skipping with an RB comb offset and/or RE comb offset.

In some aspects, the base station may detect DMRS energy to determine whether the UE has skipped a PUSCH transmission in CG resources. In some aspects, the base station may detect a power level of a subset of resources to detect whether the UE has skipped a PUSCH transmission in the CG resources. A power level of the subset of resources may be higher than a power level of the unused subset of resources, and the lower power level may indicate resources for which the UE skipped the PUSCH transmission. The use of the power level or the DMRS energy to detect skipping may lower the signaling overhead while allowing the UE flexibility in selecting the resources of the configured grant to use for the uplink transmission.

After receiving the skipping information, at 1008, the base station 1004 may configure, or schedule, the UE 1002, at 1010, to transmit SRS and/or CSI based reports on the upcoming configured grant occasions that the UE will skip. The base station 1004, may configure or schedule the UE to transmit SRS, transmit CSI based reports, transmit both SRS and CSI-based reports, or to transmit a part of a CSI based report. At 1010, the base station 1004 may configure the UE with a type of SRS/CSI-based report pattern (e.g., with information such as parameters for the transmission of the SRS/CSI based report) using RRC configuration signaling in a time window. The time window may refer to a periodicity or time duration in which the UE transmits the SRS or CSI-RS based report with a same configuration pattern.

In some aspects, the base station 1004 may activate the RRC configuration, at 1012, such as by transmitting a MAC-CE or DCI indicating to the UE 1002 that the configuration/scheduling is activated. The UE 1002 may transmit the SRS 1014 and/or the CSI based report 1016 in a skipped configured grant occasion based on the configuration/scheduling, at 1010, and/or the activation, at 1012. The base station 1004 may use the SRS and CSI based report to determine a communication parameter, e.g., as described in connection with any of FIGS. 7-9.

In some aspects, a reconfiguration may overwrite the configuration pattern provided at 1010. For example, if the UE 1002 receives an RRC reconfiguration from the base station 1004, and may apply the RRC reconfiguration in place of the configuration received at 1010. In some aspects, the base station may deactivate the configured/scheduled pattern from 1010. For example, at 1018, FIG. 10 illustrates that the base station 1004 may deactivate the configuration/scheduling or provide a reconfiguration. The UE 1002 may cease to transmit the SRS/CSI based report in the skipped configured grant occasions based on the deactivation or may transmit the SRS/CSI based report in the skipped configured grant occasions based on the new configuration.

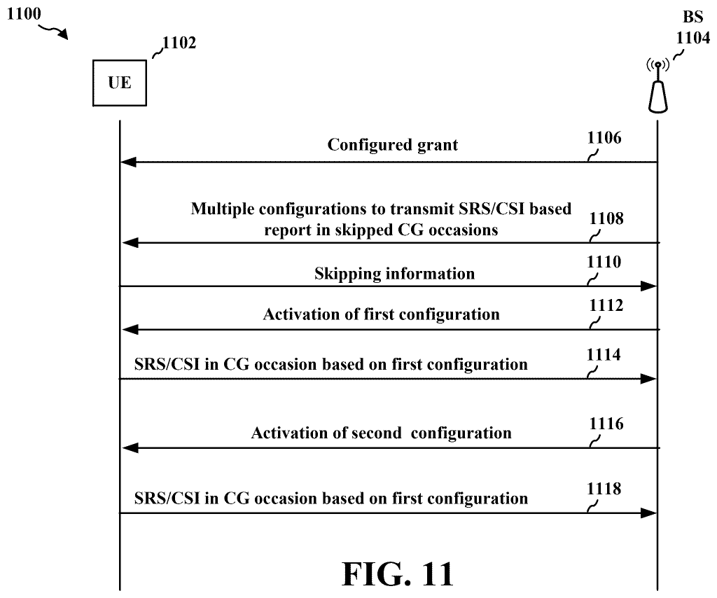

In some aspects, the base station may configure the UE with multiple configured patterns of SRS/CSI-based report for transmitting SRS/CSI-based reports in skipped configured grant occasions, and may activate configurations from among the multiple configurations. FIG. 11 illustrates an example communication flow 1100 between a UE 1102 and a base station 1104 that includes multiple configuration to transmit SRS and/or a CSI based report in skipped configured grant configuration occasions. As shown at 1106, the base station 1104 transmits a configured grant 1106 to the UE 1102 that indicates the parameters of the configured grant, e.g., as described in connection with 412 in FIG. 4B or any of FIGS. 6A-6C.

As described in connection with FIGS. 7 and 10, the UE 1102 may determine one or more configured grant occasions for which the UE will skip PUSCH transmission or have a PUSCH transmission than is smaller than the configured grant occasion resources. The UE 1102 may transmit the skipping information 1110 to the base station 1104, e.g., as described in connection with FIG. 10. For example, the UE may be aware of the configured grant occasion that will be skipped based on traffic in a buffer.

As illustrated at 1108, the base station 1104 may configure the UE with multiple types of SRS/CSI-based report patterns, e.g., similar to the single configuration/scheduling pattern described in connection with FIG. 10. The configuration 1108 may be provided to the UE 1102 using RRC and/or a MAC-CE. As illustrated at 1112, the base station 1104 may activate one of the configurations/patterns. In some aspects, the activation may be provided in DCI. In some aspects, the DCI may be a configured grant activation/reactivation DCI or a DCI carrying ACK/NACK (e.g., ACK/NACK feedback for a PUSCH transmission based on the configured grant).

FIG. 11 illustrates that the base station 1104 may activate a first configuration/scheduling pattern, at 1112. Then, at 1114, the UE 1102 may transmit the SRS/CSI based report in one or more configured grant occasions based on the first configuration/scheduling pattern than is activated. At 1116, the base station 1104 may activate a second configuration/scheduling pattern. Then, at 1118, the UE 1102 may transmit the SRS/CSI based report in one or more configured grant occasions based on the second configuration/scheduling pattern than is activated. Although the example is described for two configurations/scheduling patterns, the base station may configure, at 1108, more than two configurations/scheduling patterns.

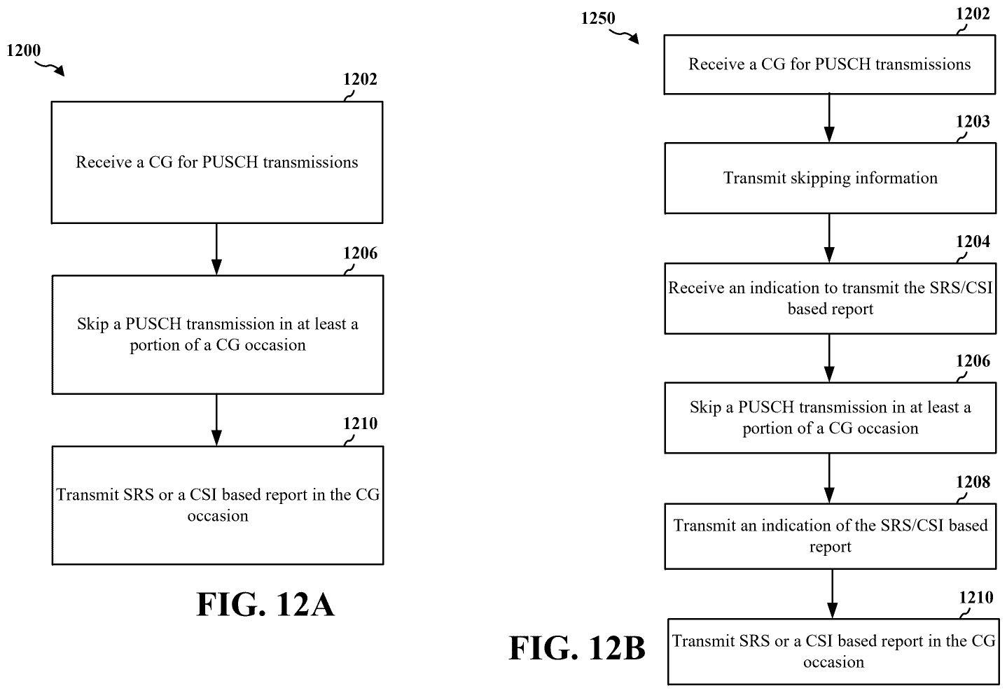

FIG. 12A is a flowchart 1200 of a method of wireless communication. The method may be performed by a UE (e.g., the UE 104, 350, 402, 504, 702, 802, 902, 1002, 1102; the apparatus 1304). The method may reduce unused resources provided for a configured grant and may also provide the UE with additional flexibility in providing SRS and/or CSI reports that may be used by a network node, such as a base station, to select a communication parameter to improve wireless communication with the UE.

At 1202, the UE receives a configured grant for PUSCH transmissions. FIGS. 4B, and 6-11 illustrate various aspects of a UE receiving a configured grant. The reception may be performed, e.g., by the configured grant component 198, the transceiver 1322, and/or the antennas 1380.

At 1206, the UE skips a PUSCH transmission in at least a portion of a configured grant occasion. The skipping may be performed, e.g., by the configured grant component 198. FIG. 6A-C illustrate examples of a UE skipping a PUSCH transmission in one or more configured grant occasions.

At 1210, the UE transmits one or more of an SRS or a CSI based report in the configured grant occasion, e.g., wherein the UE skips a PUSCH transmission. The transmission may be performed, e.g., by the configured grant component 198, the transceiver 1322, and/or the antennas 1380. FIGS. 6C and 7-11 illustrate examples of a UE transmitting an SRS and/or a CSI based report in a configured grant occasion. In some aspects, the UE may transmit the SRS in the configured grant occasion. In some aspects, the UE may transmit the CSI based report in the configured grant occasion. In some aspects, the UE may transmit the SRS and the CSI based report in the configured grant occasion.

FIG. 12B is a flowchart 1250 of a method of wireless communication. The method may be performed by a UE (e.g., the UE 104, 350, 402, 504, 702, 802, 902, 1002, 1102; the apparatus 1304). The method may reduce unused resources provided for a configured grant and may also provide the UE with additional flexibility in providing SRS and/or CSI reports that may be used by a network node, such as a base station, to select a communication parameter to improve wireless communication with the UE.

At 1202, the UE receives a configured grant for PUSCH transmissions. FIGS. 4B, and 6-11 illustrate various aspects of a UE receiving a configured grant. The reception may be performed, e.g., by the configured grant component 198, the transceiver 1322, and/or the antennas 1380.

At 1206, the UE skips a PUSCH transmission in at least a portion of a configured grant occasion. The skipping may be performed, e.g., by the configured grant component 198. FIG. 6A-C illustrate examples of a UE skipping a PUSCH transmission in one or more configured grant occasions.

At 1210, the UE transmits one or more of an SRS or a CSI based report in the configured grant occasion, e.g., wherein the UE skips a PUSCH transmission. The transmission may be performed, e.g., by the configured grant component 198, the transceiver 1322, and/or the antennas 1380. FIGS. 6C and 7-11 illustrate examples of a UE transmitting an SRS and/or a CSI based report in a configured grant occasion. In some aspects, the UE may transmit the SRS in the configured grant occasion. In some aspects, the UE may transmit the CSI based report in the configured grant occasion. In some aspects, the UE may transmit the SRS and the CSI based report in the configured grant occasion.

At 1208, the UE may transmit UCI in resources of the configured grant, the UCI indicating a presence of the one or more of the SRS or the CSI based report in the configured grant occasion and indicating at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 7 illustrates an example of a UE providing such information to a base station. The transmission may be performed, e.g., by the configured grant component 198, the transceiver 1322, and/or the antennas 1380.

In some aspects, at 1208, the UE may transmit UCI in resources of the configured grant, the UCI indicating a presence of the one or more of the SRS or the CSI based report in the configured grant occasion and transmit information indicating one or more parameters of the one or more of the SRS or the CSI based report in configured grant resources that are dedicated for the information. The information may include at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 7 illustrates an example of a UE providing such information to a base station. The transmission may be performed, e.g., by the configured grant component 198, the transceiver 1322, and/or the antennas 1380.

In some aspects, at 1204, the UE may receive DCI including acknowledgement (ACK) or negative acknowledgement (NACK) feedback for a previous PUSCH transmission, the ACK or NACK feedback indicating to the UE to transmit the one or more of the SRS or the CSI based report in one or more configured grant occasion, wherein the UE transmits the one or more of the SRS or the CSI based report in the configured grant occasion in response to the DCI. The reception may be performed, e.g., by the configured grant component 198, the transceiver 1322, and/or the antennas 1380. The DCI may indicate for the UE to transmit at least one of: the SRS based on an SRS configuration, a first CSI report based on an uplink CSI report configuration, or a second CSI report based on a downlink CSI report configuration. FIG. 8 includes an example of a UE receiving DCI indicating to use a skipped configured grant occasion.

In some aspects, at 1208, the UE may transmit information indicating one or more parameters of the one or more of the SRS or the CSI based report in resources of the configured grant that are dedicated for the information. The transmission may be performed, e.g., by the configured grant component 198, the transceiver 1322, and/or the antennas 1380. The information may include at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 9 illustrates an example of a UE providing such information to a base station.

In some aspects, at 1203, the UE may transmit skipping information indicating one or more configured grant occasions to be skipped for the PUSCH transmissions. Then, at 1204, the UE may receive a configuration or a scheduling pattern to transmit the one or more of the SRS or the CSI based report in a skipped configured grant occasion, wherein the UE transmits the one or more of the SRS or the CSI based report in the configured grant occasion in response to the configuration or the scheduling pattern. The reception may be performed, e.g., by the configured grant component 198, the transceiver 1322, and/or the antennas 1380. FIG. 10 illustrates an example of a UE providing skipping information to a base station and receiving a configuration or scheduling pattern for the transmission of SRS/CSI based reports in a skipped configured grant occasion. In some aspects, the UE may further receive, e.g., at 1204, an activation of the configuration or the scheduling pattern to transmit the one or more of the SRS or the CSI based report in the skipped configured grant occasion, wherein the UE transmits the one or more of the SRS or the CSI based report in the configured grant occasion in response to the configuration or the scheduling pattern and the activation.

In some aspects, at 1204, the UE may receive multiple configuration patterns to transmit the one or more of the SRS or the CSI based report in a skipped configured grant occasion and receive an activation of one of the multiple configuration patterns to transmit the one or more of the SRS or the CSI based report in the skipped configured grant occasion, wherein the UE transmits the one or more of the SRS or the CSI based report in the configured grant occasion based on the one of the multiple configuration patterns that is activated for the UE. The reception may be performed, e.g., by the configured grant component 198, the transceiver 1322, and/or the antennas 1380. FIG. 11 illustrates an example of a UE receiving an activation of one of multiple configurations for the transmission of SRS/CSI based reports in a configured grant occasion.

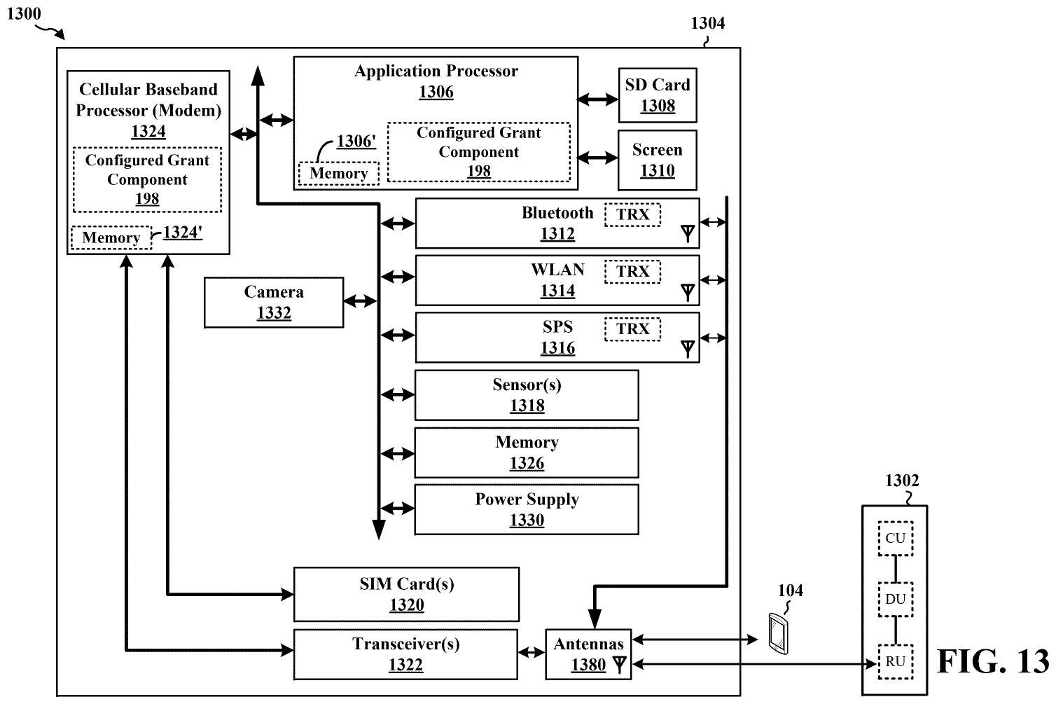

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the configured grant component 198 is configured to receive a configured grant for PUSCH transmissions, skip a PUSCH transmission in at least a portion of a configured grant occasion, and transmit one or more of a SRS or a CSI based report in the configured grant occasion. The configured grant component 198 may be configured to perform any of the aspects described in connection with FIGS. 12A, 12B, and/or any of the aspects performed by the UE in any of FIGS. 4A-11. The configured grant component 198 may be within the cellular baseband processor 1324, the application processor 1306, or both the cellular baseband processor 1324 and the application processor 1306. The configured grant component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving a configured grant for PUSCH transmissions, skipping a PUSCH transmission in at least a portion of a configured grant occasion, and transmitting one or more of a SRS or a CSI based report in the configured grant occasion. The apparatus 1304 may further include means for performing any of the aspects described in connection with FIGS. 12A, 12B, and/or any of the aspects performed by the UE in any of FIGS. 4A-11. The means may be the configured grant component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

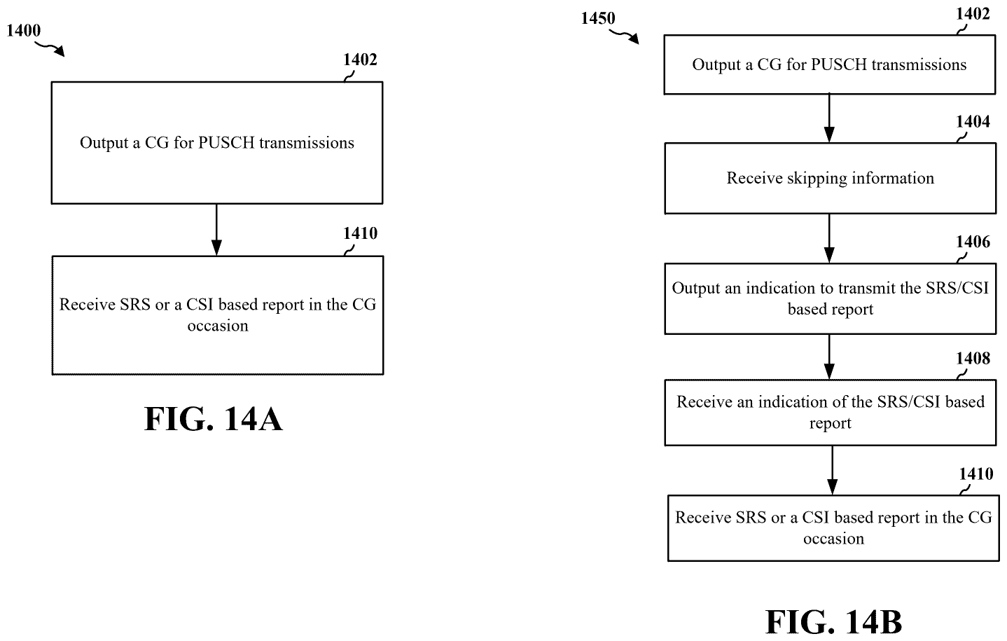

FIG. 14A is a flowchart 1400 of a method of wireless communication. The method may be performed by a network node such as a base station or a component of a base station (e.g., the base station 102, 310, 404, 502, 704, 804, 904, 004, 1104; the CU 110; the DU 130; the RU 140; the network entity 1502). The method may reduce unused resources provided for a configured grant and may also enable additional flexibility in receiving SRS and/or CSI reports that may be used by a network node, such as a base station, to select a communication parameter to improve wireless communication with the UE.

At 1402, the network node outputs for transmission a configured grant for a UE to transmit PUSCH transmissions. The output may be performed, e.g., by the configured grant component 198, the communication interface 1518 or 1538, the transceiver 1546, and/or the antennas 1580. FIGS. 4B, and 6-11 illustrate various aspects of a network node providing a configured grant to a UE.

At 1410, the network node receives one or more of an SRS or a CSI based report in a portion of a configured grant occasion. The reception may be performed, e.g., by the configured grant component 198, the communication interface 1518 or 1538, the transceiver 1546, and/or the antennas 1580. FIGS. 6C and 7-11 illustrate examples of a network node receiving an SRS and/or a CSI based report in a configured grant occasion. In some aspects, the network node may receive the SRS in the configured grant occasion. In some aspects, the network node may receive the CSI based report in the configured grant occasion. In some aspects, the network node may receive the SRS and the CSI based report in the configured grant occasion.

FIG. 14B is a flowchart 1450 of a method of wireless communication. The method may be performed by a network node such as a base station or a component of a base station (e.g., the base station 102, 310, 404, 502, 704, 804, 904, 004, 1104; the CU 110; the DU 130; the RU 140; the network entity 1502). The method may reduce unused resources provided for a configured grant and may also enable additional flexibility in receiving SRS and/or CSI reports that may be used by a network node, such as a base station, to select a communication parameter to improve wireless communication with the UE.

At 1402, the network node outputs for transmission a configured grant for a UE to transmit PUSCH transmissions. The output may be performed, e.g., by the configured grant component 198, the communication interface 1518 or 1538, the transceiver 1546, and/or the antennas 1580. FIGS. 4B, and 6-11 illustrate various aspects of a network node providing a configured grant to a UE.

At 1410, the network node receives one or more of an SRS or a CSI based report in a portion of a configured grant occasion. The reception may be performed, e.g., by the configured grant component 198, the communication interface 1518 or 1538, the transceiver 1546, and/or the antennas 1580. FIGS. 6C and 7-11 illustrate examples of a network node receiving an SRS and/or a CSI based report in a configured grant occasion. In some aspects, the network node may receive the SRS in the configured grant occasion. In some aspects, the network node may receive the CSI based report in the configured grant occasion. In some aspects, the network node may receive the SRS and the CSI based report in the configured grant occasion.

At 1408, the network node may receive UCI in resources of the configured grant, the UCI indicating a presence of the one or more of the SRS or the CSI based report in the configured grant occasion and indicating at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 7 illustrates an example of a network node receiving such information from a UE. The reception may be performed, e.g., by the configured grant component 198, the communication interface 1518 or 1538, the transceiver 1546, and/or the antennas 1580.

In some aspects, at 1408, the network node may receive UCI in resources of the configured grant, the UCI indicating a presence of the one or more of the SRS or the CSI based report in the configured grant occasion and receive information indicating one or more parameters of the one or more of the SRS or the CSI based report in configured grant resources that are dedicated for the information. The information may include at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 7 illustrates an example of a network node receiving such information from a UE. The reception may be performed, e.g., by the configured grant component 198, the communication interface 1518 or 1538, the transceiver 1546, and/or the antennas 1580.

In some aspects, at 1406, the network node may output for transmission DCI including ACK/NACK feedback for a previous PUSCH transmission, the ACK or NACK feedback indicating to the UE to transmit the one or more of the SRS or the CSI based report in one or more configured grant occasion. The output may be performed, e.g., by the configured grant component 198, the communication interface 1518 or 1538, the transceiver 1546, and/or the antennas 1580. The DCI may indicate for the UE to transmit at least one of: the SRS based on an SRS configuration, a first CSI report based on an uplink CSI report configuration, or a second CSI report based on a downlink CSI report configuration. FIG. 8 includes an example of a network node providing DCI indicating to use a skipped configured grant occasion.

In some aspects, at 1408, the network node may decode the one or more of the SRS or the CSI based report in the configured grant occasion based on an RSRP of at least one DMRS in the configured grant occasion. The decoding may be performed, e.g., by the configured grant component 198. The information may include at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report. FIG. 9 illustrates an example of a network node decoding such information based on an RSRP measurement. In some aspects, at 1408 information indicating one or more parameters of the one or more of the SRS or the CSI based report in resources of the configured grant that are dedicated for the information. The reception may be performed, e.g., by the configured grant component 198, the communication interface 1518 or 1538, the transceiver 1546, and/or the antennas 1580.

In some aspects, at 1404, the network node may receive skipping information indicating one or more configured grant occasions to be skipped for the PUSCH transmissions. The reception may be performed, e.g., by the configured grant component 198, the communication interface 1518 or 1538, the transceiver 1546, and/or the antennas 1580. Then, at 1406, the network node may output for transmission a configuration or a scheduling pattern to transmit the one or more of the SRS or the CSI based report in a skipped configured grant occasion, wherein the network node receives the one or more of the SRS or the CSI based report in the configured grant occasion after outputting the configuration or the scheduling pattern. The output may be performed, e.g., by the configured grant component 198, the communication interface 1518 or 1538, the transceiver 1546, and/or the antennas 1580. FIG. 10 illustrates an example of a network node receiving skipping information to a base station and transmitting a configuration or scheduling pattern for the transmission of SRS/CSI based reports in a skipped configured grant occasion. In some aspects, the network node may output for transmission an activation of the configuration or the scheduling pattern to transmit the one or more of the SRS or the CSI based report in the skipped configured grant occasion, wherein the network node receives the one or more of the SRS or the CSI based report in the configured grant occasion based on the activation. The output may be performed, e.g., by the configured grant component 198, the communication interface 1518 or 1538, the transceiver 1546, and/or the antennas 1580.

In some aspects, the network node may configure the UE with multiple configuration patterns to transmit the one or more of the SRS or the CSI based report in a skipped configured grant occasion. The configuration may be performed, e.g., by the configured grant component 198. The network node may then activate one of the multiple configuration patterns to transmit the one or more of the SRS or the CSI based report in the skipped configured grant occasion, wherein the network node receives the one or more of the SRS or the CSI based report in the configured grant occasion based on the one of the multiple configuration patterns that is activated for the UE. The activation may be performed, e.g., by the configured grant component 198. FIG. 11 illustrates an example of a network node activating one of multiple configurations for the transmission of SRS/CSI based reports in a configured grant occasion.

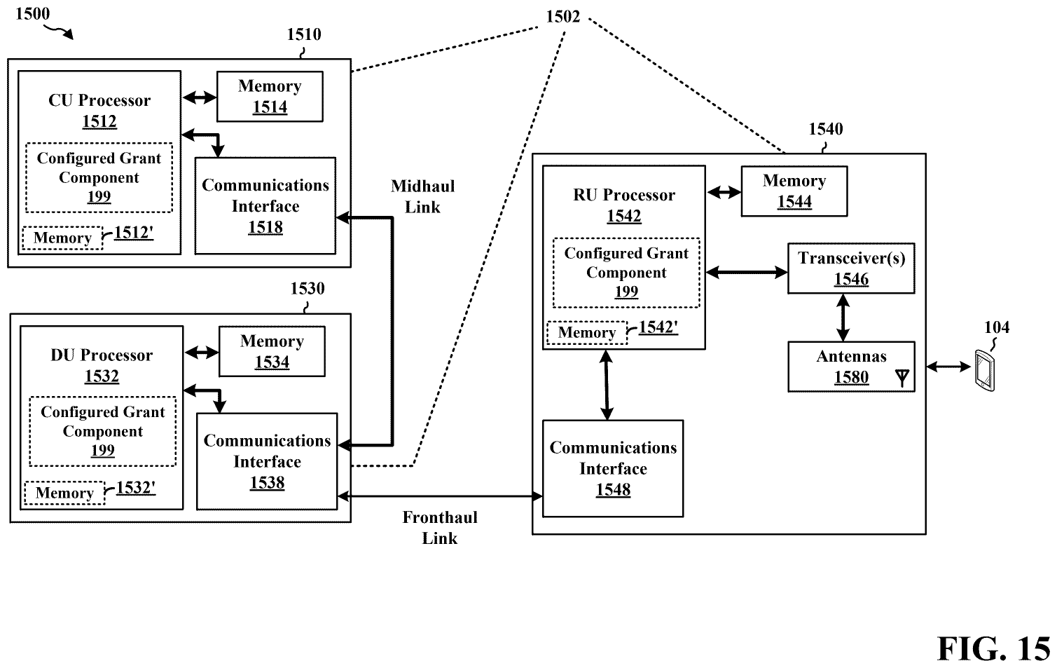

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the configured grant component 199 is configured to output for transmission a configured grant for a UE to transmit PUSCH transmissions and receive one or more of a SRS or a CSI based report in a portion of a configured grant occasion. The configured grant component 199 may be configured to perform any of the aspects described in connection with FIGS. 14A, 14B, and/or any of the aspects performed by the base station in any of FIGS. 4A-11. The configured grant component 199 may be within one or more processors of one or more of the CU 1510, DU 1530, and the RU 1540. The configured grant component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for outputting for transmission a configured grant for a UE to transmit PUSCH transmissions and means for receiving one or more of a SRS or a CSI based report in a portion of a configured grant occasion. The network entity 1502 may further include means for performing any of the aspects described in connection with FIGS. 14A, 14B, and/or any of the aspects performed by the base station in any of FIGS. 4A-11. The means may be the configured grant component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving a configured grant for PUSCH transmissions; skipping a PUSCH transmission in at least a portion of a configured grant occasion; and transmitting one or more of an SRS or a CSI based report in the configured grant occasion.

In aspect 2, the method of aspect 1 further includes that the UE transmits the SRS in the configured grant occasion.

In aspect 3, the method of aspect 1 further includes that the UE transmits the CSI based report in the configured grant occasion.

In aspect 4, the method of aspect 1 further includes that the UE transmits the SRS and the CSI based report in the configured grant occasion.

In aspect 5, the method of any of aspects 1-4 further comprises: transmitting UCI in resources of the configured grant, the UCI indicating a presence of the one or more of the SRS or the CSI based report in the configured grant occasion and indicating at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report.

In aspect 6, the method of any of aspects 1-5 further comprises: transmitting UCI in resources of the configured grant, the UCI indicating a presence of the one or more of the SRS or the CSI based report in the configured grant occasion; and transmitting information indicating one or more parameters of the one or more of the SRS or the CSI based report in configured grant resources that are dedicated for the information.

In aspect 7, the method of any of aspects 1-5 further comprises: receiving DCI including ACK or NACK feedback for a previous PUSCH transmission, the ACK or NACK feedback indicating to the UE to transmit the one or more of the SRS or the CSI based report in one or more configured grant occasion, wherein the UE transmits the one or more of the SRS or the CSI based report in the configured grant occasion in response to the DCI.

In aspect 8, the method of aspect 7 further comprises that the DCI indicates for the UE to transmit at least one of: the SRS based on an SRS configuration, a first CSI report based on an uplink CSI report configuration, or a second CSI report based on a downlink CSI report configuration.

In aspect 9, the method of any of aspects of claim 1-8 further comprises transmitting information indicating one or more parameters of the one or more of the SRS or the CSI based report in resources of the configured grant that are dedicated for the information.

In aspect 10, the method of any of aspects 1-9 further comprises transmitting skipping information indicating one or more configured grant occasions to be skipped for the PUSCH transmissions; and receiving a configuration or a scheduling pattern to transmit the one or more of the SRS or the CSI based report in a skipped configured grant occasion, wherein the UE transmits the one or more of the SRS or the CSI based report in the configured grant occasion in response to the configuration or the scheduling pattern.

In aspect 11, the method of aspect 10 further includes receiving an activation of the configuration or the scheduling pattern to transmit the one or more of the SRS or the CSI based report in the skipped configured grant occasion, wherein the UE transmits the one or more of the SRS or the CSI based report in the configured grant occasion in response to the configuration or the scheduling pattern and the activation.

In aspect 12, the method of any of aspects 1-5 further includes receiving multiple configuration patterns to transmit the one or more of the SRS or the CSI based report in a skipped configured grant occasion; and receiving an activation of one of the multiple configuration patterns to transmit the one or more of the SRS or the CSI based report in the skipped configured grant occasion, wherein the UE transmits the one or more of the SRS or the CSI based report in the configured grant occasion based on the one of the multiple configuration patterns that is activated for the UE.

Aspect 13 is an apparatus for wireless communication at a UE, comprising means for performing the method of any of aspects 1-12.

Aspect 14 is an apparatus for wireless communication at a UE, comprising memory, and at least one processor coupled to the memory and configured to perform the method of any of aspects 1-12.

In aspect 15, the apparatus of aspect 13 or 14 further includes at least one of a transceiver or an antenna.

Aspect 16, is a non-transitory computer-readable medium storing computer executable code at a UE, the code when executed by a processor causes the processor to perform the method of any of aspects 1-12.

Aspect 17 is a method of wireless communication at a network node, comprising: outputting for transmission a configured grant for a UE to transmit PUSCH transmissions; and receiving one or more of an SRS or a CSI based report in a portion of a configured grant occasion.

In aspect 18, the method of aspect 17 further includes that the network node receives the SRS in the configured grant occasion.

In aspect 19, the method of aspect 17 further includes that the network node receives the CSI based report in the configured grant occasion.

In aspect 20, the method of aspect 17 further includes that the network node receives the SRS and the CSI based report in the configured grant occasion.

In aspect 21, the method of any of aspects 17-21 further includes receiving UCI in resources of the configured grant, the UCI indicating a presence of the one or more of the SRS or the CSI based report in the configured grant occasion and indicating at least one of: an index of one or more configured grant occasions that carry the one or more of the SRS or the CSI based report, a comb level of the SRS, a comb offset of the SRS, a number of ports for the SRS, SRS configuration information, a location of the one or more of the SRS or the CSI based report in at least one of time or frequency, or a parameter of the CSI based report.

In aspect 22, the method of any of aspects 17-21 further includes receiving UCI in resources of the configured grant, the UCI indicating a presence of the one or more of the SRS or the CSI based report in the configured grant occasion; and receiving information indicating one or more parameters of the one or more of the SRS or the CSI based report in configured grant resources that are dedicated for the information.

In aspect 23, the method of any of aspects 17-21 further includes outputting for transmission DCI including ACK or NACK feedback for a previous PUSCH transmission, the ACK or NACK feedback indicating to the UE to transmit the one or more of the SRS or the CSI based report in one or more configured grant occasion.

In aspect 24, the method of aspect 23 further includes that the DCI indicates for the UE to transmit at least one of: the SRS based on an SRS configuration, a first CSI report based on an uplink CSI report configuration, or a second CSI report based on a downlink CSI report configuration.

In aspect 25, the method of any of aspects 17-21 further includes decoding the one or more of the SRS or the CSI based report in the configured grant occasion based on a RSRP of at least one DMRS in the configured grant occasion.

In aspect 26, the method of aspect 25 further includes receiving information indicating one or more parameters of the one or more of the SRS or the CSI based report in resources of the configured grant that are dedicated for the information.

In aspect 27, the method of any of aspects 17-21 further includes receiving skipping information indicating one or more configured grant occasions to be skipped for the PUSCH transmissions; and outputting for transmission a configuration or a scheduling pattern to transmit the one or more of the SRS or the CSI based report in a skipped configured grant occasion, wherein the network node receives the one or more of the SRS or the CSI based report in the configured grant occasion after outputting the configuration or the scheduling pattern.

In aspect 28, the method of aspect 27 further includes outputting for transmission an activation of the configuration or the scheduling pattern to transmit the one or more of the SRS or the CSI based report in the skipped configured grant occasion, wherein the network node receives the one or more of the SRS or the CSI based report in the configured grant occasion based on the activation.

In aspect 29, the method of any of aspects 17-21 further includes configuring the UE with multiple configuration patterns to transmit the one or more of the SRS or the CSI based report in a skipped configured grant occasion; and activating one of the multiple configuration patterns to transmit the one or more of the SRS or the CSI based report in the skipped configured grant occasion, wherein the network node receives the one or more of the SRS or the CSI based report in the configured grant occasion based on the one of the multiple configuration patterns that is activated for the UE.

Aspect 30 is an apparatus for wireless communication at a network node, comprising means for performing the method of any of aspects 17-29.

Aspect 31 is an apparatus for wireless communication at a network node, comprising memory, and at least one processor coupled to the memory and configured to perform the method of any of aspects 17-29.

In aspect 32, the apparatus of aspect 30 or 31 further includes at least one of a transceiver or an antenna.

Aspect 33, is a non-transitory computer-readable medium storing computer executable code at a UE, the code when executed by a processor causes the processor to perform the method of any of aspects 17-29.

What is claimed is:

1. A method of wireless communication at a user equipment (UE), comprising:
receiving a configured grant for physical uplink shared channel (PUSCH) transmissions;
skipping a PUSCH transmission in at least a portion of a configured grant occasion; and
transmitting one or more of a sounding reference signal (SRS) or a channel state information (CSI) based report in the configured grant occasion.

2. The method of claim 1, wherein the UE transmits the SRS in the configured grant occasion.

3. The method of claim 1, wherein the UE transmits the CSI based report in the configured grant occasion.

4. The method of claim 1, wherein the UE transmits the SRS and the CSI based report in the configured grant occasion.

5. The method of claim 1, further comprising:
transmitting uplink control information (UCI) in resources of the configured grant, the UCI indicating a presence of the one or more of the SRS or the CSI based report in the configured grant occasion and indicating at least one of:
an index of one or more configured grant occasions that carry the one or more of the SRS or the CSI based report,
a comb level of the SRS,
a comb offset of the SRS,
a number of ports for the SRS,
SRS configuration information,
a location of the one or more of the SRS or the CSI based report in at least one of time or frequency, or
a parameter of the CSI based report.

6. The method of claim 1, further comprising:
transmitting uplink control information (UCI) in resources of the configured grant, the UCI indicating a presence of the one or more of the SRS or the CSI based report in the configured grant occasion; and
transmitting information indicating one or more parameters of the one or more of the SRS or the CSI based report in configured grant resources that are dedicated for the information.

7. The method of claim 1, further comprising:
receiving downlink control information (DCI) including acknowledgement (ACK) or negative acknowledgement (NACK) feedback for a previous PUSCH transmission, the ACK or NACK feedback indicating to the UE to transmit the one or more of the SRS or the CSI based report in one or more configured grant occasion, wherein the UE transmits the one or more of the SRS or the CSI based report in the configured grant occasion in response to the DCI.

8. The method of claim 7, wherein the DCI indicates for the UE to transmit at least one of:
the SRS based on an SRS configuration,
a first CSI report based on an uplink CSI report configuration, or
a second CSI report based on a downlink CSI report configuration.

9. The method of claim 1, further comprising:
transmitting information indicating one or more parameters of the one or more of the SRS or the CSI based report in resources of the configured grant that are dedicated for the information.

10. The method of claim 1, further comprising:
transmitting skipping information indicating one or more configured grant occasions to be skipped for the PUSCH transmissions; and
receiving a configuration or a scheduling pattern to transmit the one or more of the SRS or the CSI based report in a skipped configured grant occasion, wherein the UE transmits the one or more of the SRS or the CSI based report in the configured grant occasion in response to the configuration or the scheduling pattern.

11. The method of claim 10, further comprising:
receiving an activation of the configuration or the scheduling pattern to transmit the one or more of the SRS or the CSI based report in the skipped configured grant occasion, wherein the UE transmits the one or more of the SRS or the CSI based report in the configured grant occasion in response to the configuration or the scheduling pattern and the activation.

12. The method of claim 1, further comprising:
receiving multiple configuration patterns to transmit the one or more of the SRS or the CSI based report in a skipped configured grant occasion; and
receiving an activation of one of the multiple configuration patterns to transmit the one or more of the SRS or the CSI based report in the skipped configured grant occasion, wherein the UE transmits the one or more of the SRS or the CSI based report in the configured grant occasion based on the one of the multiple configuration patterns that is activated for the UE.

13. An apparatus for wireless communication at a user equipment (UE), comprising:
a memory; and
at least one processor coupled to the memory and configured to:
receive a configured grant for physical uplink shared channel (PUSCH) transmissions;
skip a PUSCH transmission in at least a portion of a configured grant occasion; and
transmit one or more of a sounding reference signal (SRS) or a channel state information (CSI) based report in the configured grant occasion.

14. The apparatus of claim 13, wherein the at least one processor is configured to transmit the SRS in the configured grant occasion.

15. The apparatus of claim 13, wherein the at least one processor is configured to transmit the CSI based report in the configured grant occasion.

16. The apparatus of claim 13, wherein the at least one processor is configured to transmit the SRS and the CSI based report in the configured grant occasion.

17. The apparatus of claim 13, wherein the at least one processor is further configured to:
transmit uplink control information (UCI) in resources of the configured grant, the UCI indicating a presence of the one or more of the SRS or the CSI based report in the configured grant occasion and indicating at least one of:
an index of one or more configured grant occasions that carry the one or more of the SRS or the CSI based report,
a comb level of the SRS,
a comb offset of the SRS,
a number of ports for the SRS,
SRS configuration information,
a location of the one or more of the SRS or the CSI based report in at least one of time or frequency, or
a parameter of the CSI based report.

18. The apparatus of claim 13, wherein the at least one processor is further configured to:
transmit uplink control information (UCI) in resources of the configured grant, the UCI indicating a presence of the one or more of the SRS or the CSI based report in the configured grant occasion; and
transmit information indicating one or more parameters of the one or more of the SRS or the CSI based report in configured grant resources that are dedicated for the information.

19. The apparatus of claim 13, wherein the at least one processor is further configured to: receive downlink control information (DCI) including acknowledgement (ACK) or negative acknowledgement (NACK) feedback for a previous PUSCH transmission, the ACK or NACK feedback indicating to the UE to transmit the one or more of the SRS or the CSI based report in one or more configured grant occasion, wherein the UE transmits the one or more of the SRS or the CSI based report in the configured grant occasion in response to the DCI.

20. The apparatus of claim 19, wherein the DCI indicates to transmit at least one of:
the SRS based on an SRS configuration,
a first CSI report based on an uplink CSI report configuration, or
a second CSI report based on a downlink CSI report configuration.

21. The apparatus of claim 13, wherein the at least one processor is further configured to:
transmit information indicating one or more parameters of the one or more of the SRS or the CSI based report in resources of the configured grant that are dedicated for the information.

22. The apparatus of claim 13, wherein the at least one processor is further configured to:
transmit skipping information indicating one or more configured grant occasions to be skipped for the PUSCH transmissions; and
receive a configuration or a scheduling pattern to transmit the one or more of the SRS or the CSI based report in a skipped configured grant occasion, wherein the UE transmits the one or more of the SRS or the CSI based report in the configured grant occasion in response to the configuration or the scheduling pattern.

23. The apparatus of claim 22, wherein the at least one processor is further configured to:
receive an activation of the configuration or the scheduling pattern to transmit the one or more of the SRS or the CSI based report in the skipped configured grant occasion, wherein the UE transmits the one or more of the SRS or the CSI based report in the configured grant occasion in response to the configuration or the scheduling pattern and the activation.

24. The apparatus of claim 13, wherein the at least one processor is further configured to:
receive multiple configuration patterns to transmit the one or more of the SRS or the CSI based report in a skipped configured grant occasion; and
receive an activation of one of the multiple configuration patterns to transmit the one or more of the SRS or the CSI based report in the skipped configured grant occasion, wherein the UE transmits the one or more of the SRS or the CSI based report in the configured grant occasion based on the one of the multiple configuration patterns that is activated for the UE.

25. The apparatus of claim 13, further comprising:
at least one transceiver coupled to the at least one processor and configured to transmit the one or more of the SRS or the CSI based report.

26. A method of wireless communication at a network node, comprising:
outputting for transmission a configured grant for a user equipment (UE) to transmit physical uplink shared channel (PUSCH) transmissions; and
receiving one or more of a sounding reference signal (SRS) or a channel state information (CSI) based report in a portion of a configured grant occasion.

27. The method of claim 26, further comprising:
receiving uplink control information (UCI) in resources of the configured grant, the UCI indicating a presence of the one or more of the SRS or the CSI based report in the configured grant occasion and indicating at least one of:
an index of one or more configured grant occasions that carry the one or more of the SRS or the CSI based report,
a comb level of the SRS,
a comb offset of the SRS,
a number of ports for the SRS,
SRS configuration information,
a location of the one or more of the SRS or the CSI based report in at least one of time or frequency, or
a parameter of the CSI based report.

28. An apparatus for wireless communication at a network node, comprising:
a memory; and
at least one processor coupled to the memory and configured to:
output for transmission a configured grant for a user equipment (UE) to transmit physical uplink shared channel (PUSCH) transmissions; and
receive one or more of a sounding reference signal (SRS) or a channel state information (CSI) based report in a portion of a configured grant occasion.

29. The apparatus of claim 28, wherein the at least one processor is further configured to:
receive uplink control information (UCI) in resources of the configured grant, the UCI indicating a presence of the one or more of the SRS or the CSI based report in the configured grant occasion and indicating at least one of:
an index of one or more configured grant occasions that carry the one or more of the SRS or the CSI based report,
a comb level of the SRS,
a comb offset of the SRS,
a number of ports for the SRS,
SRS configuration information,
a location of the one or more of the SRS or the CSI based report in at least one of time or frequency, or
a parameter of the CSI based report.

30. The apparatus of claim 28, wherein the at least one processor is further configured to:
output for transmission downlink control information (DCI) including acknowledgement (ACK) or negative acknowledgement (NACK) feedback for a previous PUSCH transmission, the ACK or NACK feedback indicating to the UE to transmit the one or more of the SRS or the CSI based report in one or more configured grant occasion.
